(19) United States
(12) Patent Application Publication
(10) Pub. No.: US 2020/0076933 A1
(43) Pub. Date: Mar. 5, 2020

(54) DISPLAY CONTROL METHOD AND MOBILE TERMINAL

(71) Applicant: VIVO MOBILE COMMUNICATION CO., LTD., Chang'an DongGuan City (CN)

(72) Inventor: Min XIAO, Chang'an DongGuan City (CN)

(21) Appl. No.: 16/493,818

(22) PCT Filed: Mar. 8, 2018
(86) PCT No.: PCT/CN2018/078434

§ 371 Date: Sep. 13, 2019

(30) Foreign Application Priority Data
Mar. 13, 2017 (CN) 201710145491.2

(51) Int. Cl. H04M 1/02; G06F 1/16; G06F 21/32; G06F 1/3234

(52) U.S. Cl. CPC H04M 1/0268; G06F 1/3265; G06F 21/32; G06F 1/1616

(57) ABSTRACT

A display control method and a mobile terminal are provided. The display control method is applied to the mobile terminal, the mobile terminal includes a foldable screen, and the foldable screen includes a first screen and a second screen. The display control method includes: when the foldable screen is in a first folded state, collecting an image in front of the first screen and an image in front of the second screen to acquire a first image and a second image, the first screen and the second screen being both located at an outer surface of the mobile terminal in the first folded state; selecting one of the first screen and the second screen as a display screen in accordance with the first image and the second image, and shutting down the other one of the first screen and the second screen; and controlling the display screen for display.

### CROSS-REFERENCE TO RELATED APPLICATION

The present application is the U.S. national phase of PCT Application No. PCT/CN2018/078434 filed on Mar. 8, 2018, which claims a priority of the Chinese patent application No. 201710145491.2 filed on Mar. 13, 2017, which is incorporated herein by reference in its entirety.

### TECHNICAL FIELD

The present disclosure relates to the field of communication technology, in particular to a display control method and a mobile terminal.

### BACKGROUND

Currently, mobile terminals (e.g., mobile phones and tablet computers) are provided with various functions, e.g., a user may chat online, take a photo, listen to music and play video conveniently through the mobile terminal. In actual use, in order to provide a better user experience, usually it is necessary to provide the mobile terminal with a larger screen. In order to facilitate user's operations and reduce the power consumption, it is necessary to provide the mobile terminal with a smaller screen.

Along with the development of the screen technology, a foldable screen has been presented. When the foldable screen is unfolded, a full-screen display function is provided so as to meet the user's requirement on a large screen. When two parts of the foldable screen are folded in a face-to-face manner, the foldable screen is powered off. However, when the foldable screen is not folded in a face-to-face manner, i.e., unfolded, the two parts of the foldable screen are both in an on state, resulting in relatively large power consumption and a relatively small duration. In the related art, a brightness value of the foldable screen is adjusted down so as to reduce the power consumption of the foldable screen, but at this time, a display effect is adversely affected.

There is no efficient scheme for solving the problem in the related art where the mobile terminal with the foldable screen is provided with a short duration when the foldable screen is unfolded and turned on.

### SUMMARY

An object of the present disclosure is to provide a display control method and a mobile terminal, so as to solve the problem in the related art where the mobile terminal with the foldable screen is provided with a short duration when the foldable screen is unfolded and turned on.

In one aspect, the present disclosure provides in some embodiments a display control method for a mobile terminal. The mobile terminal includes a foldable screen, and the foldable screen includes a first screen and a second screen. The display control method includes: when the foldable screen is in a first folded state, collecting an image in front of the first screen and an image in front of the second screen to acquire a first image and a second image, the first screen and the second screen being both located at an outer surface of the mobile terminal in the first folded state; selecting one of the first screen and the second screen as a display screen in accordance with the first image and the second image, and shutting down the other one of the first screen and the second screen; and controlling the display screen for display.

In another aspect, the present disclosure provides in some embodiments a mobile terminal, including a foldable screen. The foldable screen includes a first screen and a second screen. The mobile terminal further includes: a collection module configured to, when the foldable screen is in a first folded state, collect an image in front of the first screen and an image in front of the second screen to acquire a first image and a second image, the first screen and the second screen being both located at an outer surface of the mobile terminal in the first folded state; a selection module configured to select one of the first screen and the second screen as a display screen in accordance with the first image and the second image, and shut down the other one of the first screen and the second screen; and a first control module configured to control the display screen for display.

In yet another aspect, the present disclosure provides in some embodiments a mobile terminal, including a foldable screen. The foldable screen includes a first screen and a second screen. The mobile terminal further includes a memory, a processor, and a computer program stored in the memory and executed by the processor. The processor is configured to execute the computer program so as to implement the above-mentioned display control method.

According to the embodiments of the present disclosure, when the foldable screen is in the first folded state, the image in front of the first screen and the image in front of the second screen is collected to acquire the first image and the second image. In the first folded state, the first screen and the second screen are both located at the outer surface of the mobile terminal. Next, one of the first screen and the second screen is selected as the display screen in accordance with the first image and the second image, and the other one of the first screen and the second screen is shut down. Then, the display screen is controlled for display. As a result, when the foldable screen is in the first folded state, it is able to select one screen of the foldable screen for display, thereby to reduce the power consumption and prolong the duration.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Apparently, the following drawings merely relate to some embodiments of the present disclosure, and based on these drawings, a person skilled in the art may obtain the other drawings without any creative effort.

FIG. 1 is a flow chart of a display control method according to some embodiments of the present disclosure;

FIG. 2 is another flow chart of the display control method according to some embodiments of the present disclosure;

FIG. 3 is a schematic view showing a foldable screen in a first folded state according to an embodiment of the present disclosure;

FIG. 4 is a schematic view showing the foldable screen in an unfolded state according to an embodiment of the present disclosure;

FIG. 5 is a schematic view showing a mobile terminal according to some embodiments of the present disclosure;

FIG. 6 is another schematic view showing the mobile terminal according to some embodiments of the present disclosure;

FIG. 7 is yet another schematic view showing the mobile terminal according to some embodiments of the present disclosure;

FIG. 8 is still yet another schematic view showing the mobile terminal according to some embodiments of the present disclosure;

FIG. 9 is still yet another schematic view showing the mobile terminal according to some embodiments of the present disclosure; and

FIG. 10 is still yet another schematic view showing the mobile terminal according to some embodiments of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

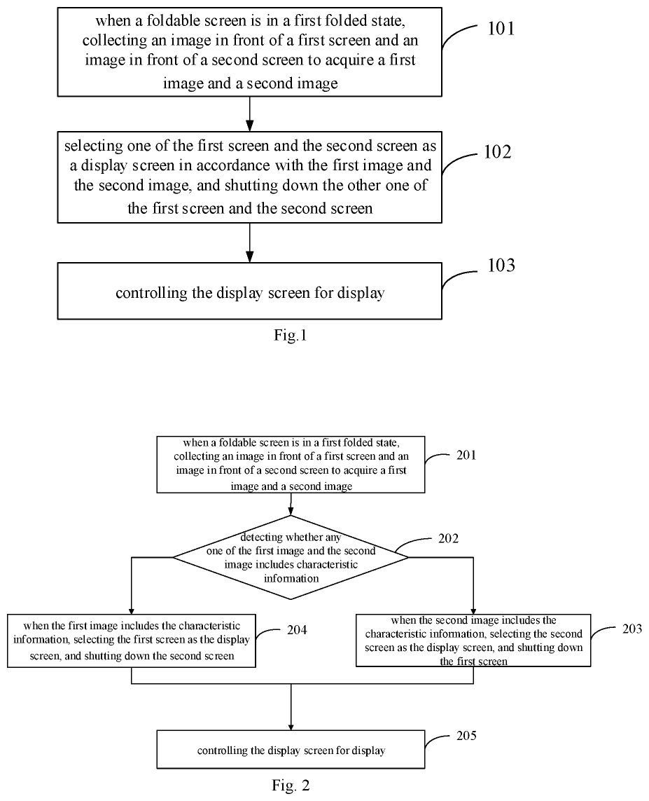

The present disclosure provides in some embodiments a display control method for a mobile terminal. The mobile terminal includes a foldable screen, and the foldable screen includes a first screen and a second screen. As shown in FIG. 1, the display control method may include the following steps.

Step 101: when the foldable screen is in a first folded state, collecting an image in front of the first screen and an image in front of the second screen to acquire a first image and a second image, the first screen and the second screen being both located at an outer surface of the mobile terminal in the first folded state.

In the embodiments of the present disclosure, the mobile terminal is any mobile terminal having a foldable screen, e.g., a mobile phone, a tablet personal computer, a laptop computer, a personal digital assistant (PDA), a Mobile Internet Device (MID) or a wearable device. The foldable screen is an Active Matrix/Organic Light-Emitting Diode (AMOLED) screen.

To be specific, when the foldable screen is in a closed state, i.e., as one type of the folded state, the first screen and the second screen is arranged in a face-to-face manner. When the foldable screen is the first folded state, the first screen is located at one side of the mobile terminal, and the second screen is located at the other side of the mobile terminal. At this time, the first screen and the second screen of the foldable screen is both located at the outer surface of the mobile terminal, and they are both used for display. In other words, in the first folded state, the first screen and the second screen is rotated by approximately 360° from the closed state, so as to enable the first screen and the second screen to be arranged in a back-to-back manner rather than in a face-to-face manner. In a possible embodiment of the present disclosure, at least one camera facing a same direction as the first screen is arranged at the outer surface of the mobile terminal where the first screen is located, and at least one camera facing a same direction as the second screen is arranged at the out surface of the mobile terminal where the second screen is located, so as to collect the image in front of the first screen and the image in front of the second screen respectively, thereby to acquire the first image and the second image. The first image is acquired through collecting the image in front of the first screen, and the second image is acquired through collecting the image in front of the second screen.

Step 102: selecting one of the first screen and the second screen as a display screen in accordance with the first image and the second image, and shutting down the other one of the first screen and the second screen.

In the embodiments of the present disclosure, a position of a user is determined in accordance with the first image and the second image, and then the first screen or the second screen is selected for display in accordance with the position of the user. To be specific, when the first screen is selected as the display screen, the second screen is shut down, and when the second screen is selected as the display screen, the first screen is shut down.

Step 103: controlling the display screen for display.

To be specific, a display content to be displayed by the mobile terminal is displayed on the display screen.

According to the display control method in the embodiments of the present disclosure, when the foldable screen is in the first folded state, the image in front of the first screen and the image in front of the second screen is collected to acquire the first image and the second image. In the first folded state, the first screen and the second screen are both located at the outer surface of the mobile terminal. Next, one of the first screen and the second screen is selected as the display screen in accordance with the first image and the second image, and the other one of the first screen and the second screen is shut down. Then, the display screen is controlled for display. As a result, when the foldable screen is in the first folded state, it is able to select one screen of the foldable screen for display, thereby to reduce the power consumption and prolong the duration.

As shown in FIG. 2, the present disclosure further provides in some embodiments a display control method for a mobile terminal. The mobile terminal includes a foldable screen, and the foldable screen includes a first screen and a second screen. In the embodiments of the present disclosure, selecting one of the first screen and the second screen as a display screen in accordance with the first image and the second image and shutting down the other one of the first screen and the second screen may include: detecting whether any one of a first image and a second image includes characteristic information, the characteristic information including face information and eyeball information; when the first image includes the characteristic information, selecting the first screen as the display screen, and shutting down the second screen; and when the second image includes the characteristic information, selecting the second screen as the display screen, and shutting down the first screen.

As shown in FIG. 2, the display control method may include the following steps.

Step 201: when the foldable screen is in a first folded state, collecting an image in front of the first screen and an image in front of the second screen to acquire the first image and the second image, the first screen and the second screen being both located at an outer surface of the mobile terminal in the first folded state.

In the embodiments of the present disclosure, the mobile terminal is any mobile terminal having a foldable screen, e.g., a mobile phone, a tablet personal computer, a laptop computer, a PDA, an MID or a wearable device. The foldable screen is an AMOLED screen.

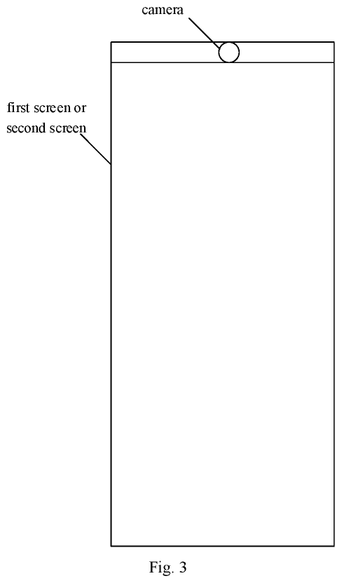

To be specific, when the foldable screen is the first folded state, the first screen is located at one side of the mobile terminal, and the second screen is located at the other side of the mobile terminal. At this time, the first screen and the second screen of the foldable screen is both located at the outer surface of the mobile terminal, and they are both used for display. As shown in FIG. 3, in a possible embodiment of the present disclosure, at least one camera facing a same direction as the first screen is arranged at the outer surface of the mobile terminal where the first screen is located, and at least one camera facing a same direction as the second screen is arranged at the out surface of the mobile terminal where the second screen is located, so as to collect the image in front of the first screen and the image in front of the second screen respectively, thereby to acquire the first image and the second image. The first image is acquired through collecting the image in front of the first screen, and the second image is acquired through collecting the image in front of the second screen.

Step 202: detecting whether any one of the first image and the second image includes characteristic information, the characteristic information including face information or eyeball information.

In the embodiments of the present disclosure, the characteristic information may include face information, eyeball information, etc. To be specific, whether any one of the first image and the second image includes the face information is detected through a face detection algorithm. The face detection algorithm is, but not limited to, an algorithm based on correction matching, an eigenface algorithm, a linear discriminant analysis algorithm, a singular value decomposition algorithm or a neural network algorithm. In addition, whether any one of the first image and the second image includes the eyeball information is detected through an eyeball identification algorithm. The eyeball information may include one or more of a position of an eyeball, a pupil center, information about iris, and a line-of-sight direction. The eyeball identification algorithm may include, but not limited to, Hough transformation, AdaBoost classifier or a template matching algorithm.

Step 203: when the first image includes the characteristic information, selecting the first screen as the display screen, and shutting down the second screen.

In the embodiments of the present disclosure, when the first image includes the characteristic information, it means that the user is located in front of the first screen. At this time, the first screen is selected as the display screen, the second screen is shut down, and Step 205 is performed.

In a possible embodiment of the present disclosure, in order to improve the security of the mobile terminal during the use thereof, the selecting the first screen as the display screen when the first image includes the characteristic information may include: performing identity authentication in accordance with the characteristic information included in the first image; and when the identity authentication has been performed successfully, selecting the first screen as the display screen.

In the embodiments of the present disclosure, when the first image includes the characteristic information, the identity authentication is further performed in accordance with the characteristic information. For example, a matching operation is performed on the characteristic information and preset characteristic information about a user having a usage right, and when the characteristic information matches the preset characteristic information about the user having the usage right, the identity authentication is performed successfully. At this time, the first screen is selected as the display screen, and Step 205 is performed. When the characteristic information does not match the preset characteristic information about the user having the usage right, the identity authentication is performed unsuccessfully. At this time, the first screen is shut down.

To be specific, when the characteristic information includes the face information, a matching operation is performed on the face information included in the first image and pre-stored face information about the user having the usage right. When the characteristic information includes the eyeball information, whether the eye information included in the first image matches a predetermined eyeprint or iris is determined.

Step 204: when the second image includes the characteristic information, selecting the second screen as the display screen, and shutting down the first screen.

In the embodiments of the present disclosure, when the second image includes the characteristic information, it means that the user is located in front of the second screen. At this time, the second screen is selected as the display screen, the first screen is shut down, and Step 205 is performed.

In a possible embodiment of the present disclosure, in order to improve the security of the mobile terminal during the use thereof, the selecting the second screen as the display screen when the second image includes the characteristic information may include: performing identity authentication in accordance with the characteristic information included in the second image; and when the identity authentication has been performed successfully, selecting the second screen as the display screen.

In the embodiments of the present disclosure, when the second image includes the characteristic information, the identity authentication is further performed in accordance with the characteristic information. For example, a matching operation is performed on the characteristic information and the preset characteristic information about the user having the usage right, and when the characteristic information matches the preset characteristic information about the user having the usage right, the identity authentication is performed successfully. At this time, the second screen is selected as the display screen, and Step 205 is performed. When the characteristic information does not match the preset characteristic information about the user having the usage right, the identity authentication is performed unsuccessfully. At this time, the second screen is shut down.

To be specific, when the characteristic information includes the face information, a matching operation is performed on the face information included in the second image and pre-stored face information about the user having the usage right. When the characteristic information includes the eyeball information, whether the eye information included in the second image matches the predetermined eyeprint or iris is determined.

In a possible embodiment of the present disclosure, upon the detection of the characteristic information in the first image or the second image, whether the user is watching the screen is determined in accordance with a line-of-sight direction. The screen is selected for display only when the user is currently watching the screen.

It should be appreciated that, when both the first image and the second image do not include the characteristic information, neither the first screen nor the second screen is selected for display. At this time, both the first screen and the second screen is shut down. When both the first image and the second image include the characteristic information, the identity authentication is further performed, and merely the screen currently watched by the authenticated user is selected for display.

Step 205: controlling the display screen for display.

In the embodiments of the present disclosure, the screen facing the user is selected for display, and the screen not facing the user is shut down.

In a possible embodiment of the present disclosure, subsequent to controlling the display screen for display, the display control method may further include: detecting whether a rotation angle of a space attitude of the mobile terminal is greater than a predetermined value; and when the rotation angle of the space attitude of the mobile terminal is greater than the predetermined value, performing a switching operation between the first screen and the second screen for a display content.

In the embodiments of the present disclosure, after one of the screens of the foldable screen has been selected for display, the rotation angle of the space attitude of the mobile terminal is detected in real time. To be specific, the rotation angle of the space attitude of the mobile terminal is detected by an accelerometer or a gyroscope. When the rotation angle is greater than the predetermined value, a switching operation is performed between the first screen and the second screen for the display content. The display content is a content currently displayed by the mobile terminal. To be specific, when the display content was displayed on the first screen before the rotation of the space attitude of the mobile terminal, the display content is switched to be displayed on the second screen, i.e., the second screen is selected as the display screen, and the first screen is shut down (the second screen was not selected for display previously, so after the switching, the first screen is shut down). When the display content was displayed on the second screen before the rotation of the space attitude of the mobile terminal, the display content is switched to be displayed on the first screen, i.e., the first screen is selected as the display screen, and the second screen is shut down (the first screen was not selected for display previously, so after the switching, the second screen is shut down).

In the embodiments of the present disclosure, it is able to automatically control the switching of the display screen in accordance with information about a change in the space attitude of the mobile terminal, thereby to facilitate the switching operation on the screens.

It should be appreciated that, in the embodiments of the present disclosure, subsequent to controlling the display screen for display, the image in front of the first screen and the image in front of the second screen is collected continuously, and then the display screen is switched in accordance with the image in front of the first screen and the image in front of the second screen.

In a possible embodiment of the present disclosure, when the foldable screen is switched from the unfolded state to the first folded state, the controlling the display screen for display may include: scaling down a display interface on the foldable screen in the unfolded state in accordance with a predetermined first proportion; and displaying the scaled-down display interface on the display screen.

In the embodiments of the present disclosure, when the foldable screen is in the unfolded state, the first screen and the second screen is both used for display. When the foldable screen is in the first folded state, merely one of the first screen and the second screen is selected for display. Hence, when the folded screen is switched from the unfolded state to the first folded state, a size of the display screen may decrease. In order to enable the display interface to be adapted to a current display screen, it is necessary to scale down the display interface in the unfolded state on the foldable screen in accordance with the first predetermined proportion, and display the scaled-down display interface on the current display screen. In a possible embodiment of the present disclosure, the first predetermined proportion is set in accordance with a size of the foldable screen in the unfolded state and a size of the foldable screen in the first folded state.

In a possible embodiment of the present disclosure, the display control method may further include: when the foldable screen is switched from the first folded state to the unfolded state, scaling up the display interface in the first folded state on the foldable screen in accordance with a second predetermined proportion; and displaying the scaled-up display interface on the first screen and the second screen.

In the embodiments of the present disclosure, when the foldable screen in the unfolded state, the first screen and the second screen is both used for display. When the foldable screen is in the first folded state, merely one of the first screen and the second screen is selected for display. Hence, when the folded screen is switched from the first folded state to the unfolded state, a size of the display screen may increase. In order to enable the display interface to be adapted to a current display screen, it is necessary to scale up the display interface in the first folded state on the foldable screen in accordance with the second predetermined proportion, and display the scaled-up display interface on the current display screen. In a possible embodiment of the present disclosure, the second predetermined proportion is set in accordance with the size of the foldable screen in the unfolded state and the size of the foldable screen in the first folded state.

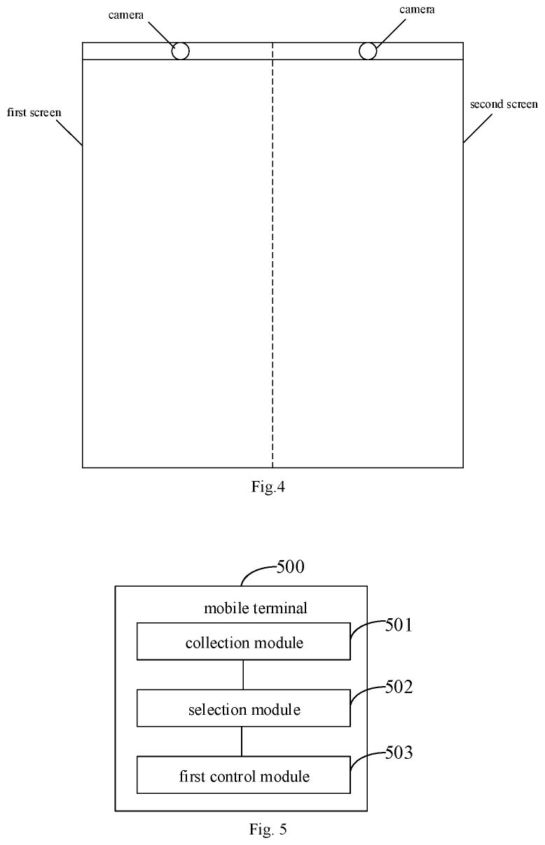

In the embodiments of the present disclosure, when it is necessary for the user to view a video or a webpage on a large screen, the foldable screen is unfolded, as shown in FIG. 4, so as to display the display content on both the first screen and the second screen, thereby to meet the user's requirement.

In a possible embodiment of the present disclosure, the display control method may further include, when the foldable screen is in a second folded state, shutting down the first screen and the second screen. In the second folded state, both the first screen and the second screen are located at an inner surface of the mobile terminal.

In the embodiments of the present disclosure, when the foldable screen is in the second folded state, both the first screen and the second screen is located at the inner surface of the mobile terminal. For example, the first screen and the second screen is laminated one on another, and at this time, neither the first screen nor the second screen is selected for display.

In the embodiments of the present disclosure, when it is unnecessary for the screen of the mobile terminal to display any content, i.e., when the foldable screen is in the second folded state, the first screen and the second screen is shut down. In this way, it is able to further reduce the power consumption of the mobile terminal, and prolong the duration of the mobile terminal.

According to the display control method in the embodiments of the present disclosure, when the foldable screen is in the first folded state, the image in front of the first screen and the image in front of the second screen is collected, so as to acquire the first image and the second image. Next, whether any one of the first image and the second image includes the characteristic information is detected. When the first image includes the characteristic information, the first screen is selected as the display screen and the second screen is shut down. When the second image includes the characteristic information, the second screen is selected as the display screen, and the first screen is shut down. Then, the display screen is controlled for display. Through the detection of the characteristic information, it is able to determine a screen facing the user, select the screen facing the user as the display screen for display, and shut down the other screen. As a result, it is able to improve the accuracy of a selection result of the display screen, and meet the user's requirement on a small-screen operation and a long duration.

The present disclosure further provides in some embodiments a mobile terminal 500 which, as shown in FIG. 5, includes a collection module 501, a selection module 502 and a first control module 503. The collection module 501 is configured to, when the foldable screen is in a first folded state, collect an image in front of the first screen and an image in front of the second screen to acquire a first image and a second image, and the first screen and the second screen are both located at an outer surface of the mobile terminal in the first folded state. The selection module 502 is configured to select one of the first screen and the second screen as a display screen in accordance with the first image and the second image, and shut down the other one of the first screen and the second screen. The first control module 503 is configured to control the display screen for display.

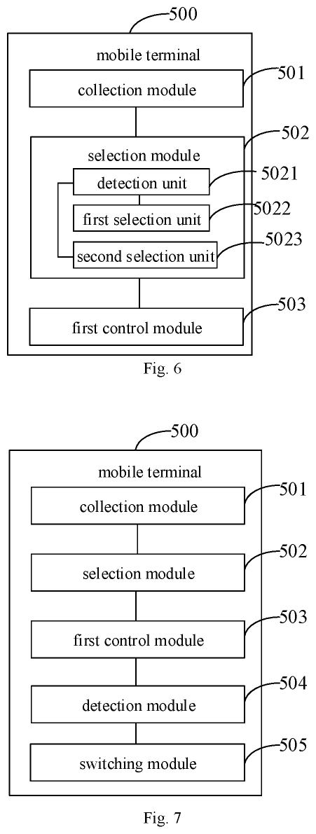

In a possible embodiment of the present disclosure, as shown in FIG. 6, the selection module 502 may include: a detection unit 5021 configured to detect whether the first image and the second image each include characteristic information, the characteristic information including face information or eyeball information; a first selection unit 5022 configured to, when the first image includes the characteristic information, select the first screen as the display screen, and shut down the second screen; and a second selection unit 5023 configured to, when the second image includes the characteristic information, select the second screen as the display screen, and shut down the first screen.

In a possible embodiment of the present disclosure, the first selection unit 5022 is further configured to: perform identity authentication in accordance with the characteristic information included in the first image; and when the identity authentication is performed successfully, select the first screen as the display screen. The second selection unit 5023 is further configured to: perform the identity authentication in accordance with the characteristic information included in the second image; and when the identity authentication is performed successfully, select the second screen as the display screen.

In a possible embodiment of the present disclosure, as shown in FIG. 7, the mobile terminal 500 may further include: a detection module 504 configured to, after the display screen has been controlled for display, detect whether a rotation angle of a space attitude of the mobile terminal is greater than a predetermined value; and a switching module 505 configured to, when the rotation angle of the space attitude of the mobile terminal is greater than the predetermined value, perform a switching operation between the first screen and the second screen for a display content.

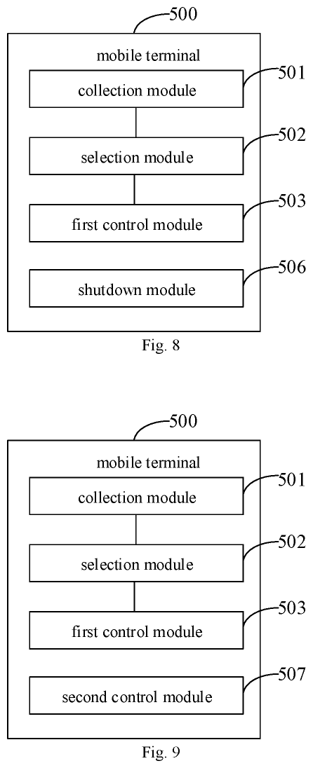

In a possible embodiment of the present disclosure, as shown in FIG. 8, the mobile terminal 500 may further include a shutdown module 506 configured to, when the foldable screen is in a second folded state, shut down the first screen and the second screen. In the second folded state, both the first screen and the second screen are located at an inner surface of the mobile terminal.

In a possible embodiment of the present disclosure, the first control module 503 is further configured to: when the foldable screen is switched from an unfolded state to the first folded state, scale down a display interface in the unfolded state on the foldable screen in accordance with a first predetermined proportion; and display the scaled-down display interface on the display screen.

In a possible embodiment of the present disclosure, as shown in FIG. 9, the mobile terminal 500 may further include a second control module 507 configured to: when the foldable screen is switched from the first folded state to the unfolded state, scale up the display interface in the first folded state on the foldable screen in accordance with a second predetermined proportion; and display the scaled-up display interface on the first screen and the second screen.

The mobile terminal 500 is capable of implementing the steps of the display control method in FIGS. 1-2, so the implementation of the mobile terminal may refer to that of the display control method mentioned hereinabove.

According to the mobile terminal 500 in the embodiments of the present disclosure, when the foldable screen is in the first folded state, the collection module 501 may collect the image in front of the first screen and the image in front of the second screen, so as to acquire the first image and the second image. In the first folded state, the first screen and the second screen is both arranged at the outer surface of the mobile terminal. The selection module 502 may select one of the first screen and the second screen as the display screen in accordance with the first image and the second image, and shut down the other one of the first screen and the second screen. The first control module 503 may control the display screen for display. As a result, when the foldable screen is in the first folded state, it is able to select one of the first screen and the second screen of the foldable screen for display, thereby to reduce the power consumption and prolong the duration.

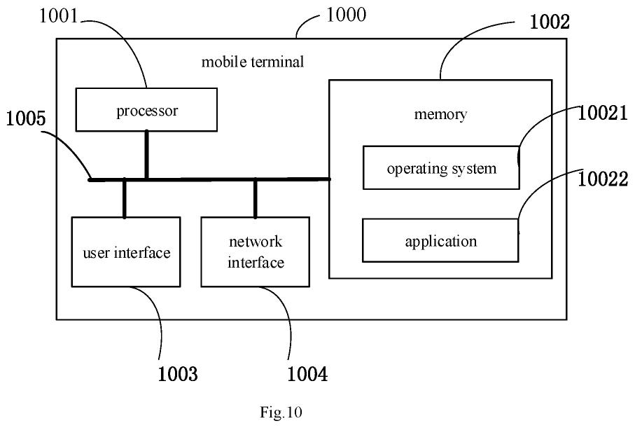

The present disclosure further provides in some embodiments a mobile terminal 1000 which, as shown in FIG. 10, includes at least one processor 1001, a memory 1002, at least one network interface 1004 and a user interface 1003. The components of the mobile terminal 1000 is coupled together through a bus system 1005. It should be appreciated that, the bus system 1005 is configured to achieve connection and communication among the components. Apart from a data bus, the bus system 1005 may further include a power source bus, a control bus and a state signal bus. For clarification, all these buses in FIG. 10 are collectedly called as bus system 1005.

The user interface 1003 may include a display, a keyboard or a pointing device (e.g., mouse, track ball, touch plate or touch panel).

It should be appreciated that, the memory 1002 is a volatile memory, a nonvolatile memory or both. The nonvolatile memory is a Read-Only Memory (ROM), a Programmable ROM (PROM), an Erasable PROM (EPROM), an electrically EPROM (EEPROM) or a flash memory. The volatile memory is a Random Access Memory (RAM) which serves as an external high-speed cache. Illustratively but not restrictively, the RAM may include Static RAM (SRAM), Dynamic RAM (DRAM), Synchronous DRAM (SDRAM), Double Data Rate SDRAM (DDRSDRAM), Enhanced SDRAM (ESDRAM), Synchronous Link DRAM (SLDRAM) or Direct Rambus RAM (DRRAM). The memory 1002 intends to include, but not limited to, the above-mentioned and any other appropriate memories.

In a possible embodiment of the present disclosure, the following elements are stored in the memory 1002: an executable module or data structure, a subset or an extended set thereof, an operating system 10021 and an application 10022.

The operating system 10021 may include various system programs, e.g., a framework layer, a core layer and a driving layer, so as to implement various basic services and process hardware-based tasks. The application 10022 may include various applications, e.g., Media Player and Browser, so as to implement various application services. The programs for implementing the above-mentioned method is included in the application 10022.

In the embodiments of the present disclosure, through calling a program or instruction stored in the memory 1002, e.g., a program or instruction stored in the application 10022, the processor 1001 is configured to: when the foldable screen is in a first folded state, collect an image in front of the first screen and an image in front of the second screen to acquire a first image and a second image, the first screen and the second screen being both located at an outer surface of the mobile terminal in the first folded state; select one of the first screen and the second screen as a display screen in accordance with the first image and the second image, and shut down the other one of the first screen and the second screen; and control the display screen for display.

The above-mentioned method is applied to, or implemented by, the processor 1001. The processor 1001 is an integrated circuit (IC) having a signal processing capability. During the implementation, the steps of the above-mentioned method is completed through an integrated logic circuit of hardware in the processor 1101 or instructions in the form of software. The processor 1001 is a general-purpose processor, a digital signal processor, an application-specific integrated circuit (ASIC), a field programmable gate array (FPGA) or any other programmable logic element, a discrete gate or transistor logic element, or a discrete hardware assembly, which is used to implement or execute the methods, steps or logic diagrams in the embodiments of the present disclosure. The general purpose processor is a microprocessor or any other conventional processor. The steps of the method in the embodiments of the present disclosure is directly implemented by the processor in the form of hardware, or a combination of hardware and software modules in the processor. The software module is located in a known storage medium such as an RAM, a flash memory, an ROM, a PROM, an EEPROM, or a register. The storage medium is located in the memory 1002, and the processor 1001 may read information stored in the memory 1002 so as to implement the steps of the method in conjunction with the hardware.

It should be appreciated that, the embodiments of the present disclosure is implemented by hardware, software, firmware, middleware, microcode or a combination thereof. For the hardware implementation, the processor may include one or more of an ASIC, a DSP, a DSP device (DSPD), a Programmable Logic Device (PLD), an FPGA, a general-purpose processor, a controller, a microcontroller, a microprocessor, any other electronic unit capable of achieving the functions in the present disclosure, or a combination thereof.

For the software implementation, the scheme in the embodiments of the present disclosure is implemented through modules capable of achieving the functions in the present disclosure (e.g., processes or functions). Software codes are stored in the memory and executed by the processor. The memory is implemented inside or outside the processor.

In a possible embodiment of the present disclosure, when selecting one of the first screen and the second screen as the display screen and shutting down the other one of the first screen and the second screen in accordance with the first image and the second image, the processor 1001 is further configured to: detect whether any one of the first image and the second image includes characteristic information, the characteristic information including face information or eyeball information; when the first image includes the characteristic information, select the first screen as the display screen, and shut down the second screen; and when the second image includes the characteristic information, select the second screen as the display screen, and shut down the first screen.

In a possible embodiment of the present disclosure, when selecting the first screen as the display screen when the first image includes the characteristic information, the processor 1001 is further configured to: perform identity authentication in accordance with the characteristic information included in the first image; and when the identity authentication is performed successfully, select the first screen as the display screen.

In a possible embodiment of the present disclosure, when selecting the second screen as the display screen when the second image includes the characteristic information, the processor 1001 is further configured to: perform the identity authentication in accordance with the characteristic information included in the second image; and when the identity authentication is performed successfully, select the second screen as the display screen.

In a possible embodiment of the present disclosure, the processor 1001 is further configured to: after the display screen has been controlled for display, detect whether a rotation angle of a space attitude of the mobile terminal is greater than a predetermined value; and a when the rotation angle of the space attitude of the mobile terminal is greater than the predetermined value, perform a switching operation between the first screen and the second screen for a display content.

In a possible embodiment of the present disclosure, when controlling the display screen for display, the processor 1001 is further configured to: when the foldable screen is switched from an unfolded state to the first folded state, scale down a display interface in the unfolded state on the foldable screen in accordance with a first predetermined proportion; and display the scaled-down display interface on the display screen.

In a possible embodiment of the present disclosure, the processor 1001 is further configured to, when the foldable screen is in a second folded state, shut down the first screen and the second screen. In the second folded state, both the first screen and the second screen are located at an inner surface of the mobile terminal.

In a possible embodiment of the present disclosure, the processor 1001 is further configured to: when the foldable screen is switched from the first folded state to the unfolded state, scale up the display interface in the first folded state on the foldable screen in accordance with a second predetermined proportion; and display the scaled-up display interface on the first screen and the second screen.

The mobile terminal 1000 is capable of implementing the steps of the display control method mentioned hereinabove, so the implementation of the mobile terminal may refer to that of the display control method mentioned hereinabove.

According to the mobile terminal 1000 in the embodiments of the present disclosure, when the foldable screen is in the first folded state, the image in front of the first screen and the image in front of the second screen is collected, so as to acquire the first image and the second image. In the first folded state, the first screen and the second screen is both arranged at the outer surface of the mobile terminal. Next, one of the first screen and the second screen is selected as the display screen in accordance with the first image and the second image, and the other one of the first screen and the second screen is shut down. Then, the display screen is controlled for display. As a result, when the foldable screen is in the first folded state, it is able to select one screen of the foldable screen for display, thereby to reduce the power consumption, prolong the duration, and solve the problem in the related art where a duration of a large-screen mobile terminal is relatively short.

It should be appreciated that, units and steps described in the embodiments of the present disclosure is implemented in the form of electronic hardware, or a combination of a computer program and the electronic hardware. Whether or not these functions are executed by hardware or software depends on specific applications or design constraints of the technical solution. Different methods are adopted with respect to the specific applications so as to achieve the described functions, without departing from the scope of the present disclosure.

It should be further appreciated that, for convenience and clarification, operation procedures of the system, device and units described hereinabove may refer to the corresponding procedures in the method embodiment, and thus will not be particularly defined herein.

It should be further appreciated that, the device and method is implemented in any other ways. For example, the embodiments for the apparatus are merely for illustrative purposes, and the modules or units are provided merely on the basis of their logic functions. During the actual application, some modules or units are combined together or integrated into another system. Alternatively, some functions of the module or units are omitted or not executed. In addition, the coupling connection, direct coupling connection or communication connection between the modules or units are implemented via interfaces, and the indirect coupling connection or communication connection between the modules or units are implemented in an electrical or mechanical form or in any other form.

The units are, or may not be, physically separated from each other. The units for displaying are, or may not be, physical units, i.e., they are arranged at a same position, or distributed on a plurality of network elements. Parts or all of the units are selected in accordance with the practical need, so as to achieve the purpose of the present disclosure.

In addition, the functional units in the embodiments of the present disclosure is integrated into a processing unit, or the functional units may exist independently, or two or more functional units are combined together.

In the case that the functional units are implemented in a software form and sold or used as a separate product, they are stored in a computer-readable medium. Based on this, the technical solutions of the present disclosure, partial or full, or parts of the technical solutions of the present disclosure contributing to the related art, may appear in the form of software products, which is stored in a storage medium and include several instructions so as to enable computer equipment (a personal computer, a server or network equipment) to execute all or parts of the steps of the method according to the embodiments of the present disclosure. The storage medium includes any medium capable of storing therein program codes, e.g., a universal serial bus (USB) flash disk, a mobile hard disk (HD), a read-only memory (ROM), a random access memory (RAM), a magnetic disk or an optical disk.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A display control method applied for a mobile terminal, the mobile terminal comprising a foldable screen, the foldable screen comprising a first screen and a second screen, the display control method comprising:
collecting an image in front of the first screen and an image in front of the second screen to acquire a first image and a second image when the foldable screen is in a first folded state, the first screen and the second screen being both located at an outer surface of the mobile terminal in the first folded state;
selecting one of the first screen and the second screen as a display screen in accordance with the first image and the second image, and shutting down the other one of the first screen and the second screen; and
controlling the display screen for display.

2. The display control method according to claim 1, wherein the selecting one of the first screen and the second screen as a display screen in accordance with the first image and the second image and shutting down the other one of the first screen and the second screen comprises:
detecting whether any one of the first image and the second image comprises characteristic information, the characteristic information comprising face information or eyeball information;
selecting the first screen as the display screen when the first image comprises the characteristic information, and shutting down the second screen; and
selecting the second screen as the display screen when the second image comprises the characteristic information, and shutting down the first screen.

3. The display control method according to claim 2, wherein the selecting the first screen as the display screen when the first image comprises the characteristic information comprises:
performing identity authentication in accordance with the characteristic information comprised in the first image; and
selecting the first screen as the display screen when the identity authentication is performed successfully,
wherein the selecting the second screen as the display screen when the second image comprises the characteristic information comprises:
performing the identity authentication in accordance with the characteristic information comprised in the second image; and
selecting the second screen as the display screen when the identity authentication is performed successfully.

4. The display control method according to claim 1, wherein subsequent to controlling the display screen for display, the display control method further comprises:
detecting whether a rotation angle of a space attitude of the mobile terminal is greater than a predetermined value; and
performing a switching operation between the first screen and the second screen for a display content when the rotation angle of the space attitude of the mobile terminal is greater than the predetermined value.

5. The display control method according to claim 1, wherein when the foldable screen is switched from an unfolded state to the first folded state, the controlling the display screen for display comprises:
scaling down a display interface in the unfolded state on the foldable screen in accordance with a first predetermined proportion; and
displaying the scaled-down display interface on the display screen.

6. The display control method according to claim 5, further comprising:
when the foldable screen is switched from the first folded state to the unfolded state, scaling up the display interface in the first folded state on the foldable screen in accordance with a second predetermined proportion; and
displaying the scaled-up display interface on the first screen and the second screen.

7. A mobile terminal, comprising a foldable screen, the foldable screen comprising a first screen and a second screen, the mobile terminal further comprising:
a collection module configured to, when the foldable screen is in a first folded state, collect an image in front of the first screen and an image in front of the second screen to acquire a first image and a second image, the first screen and the second screen being both located at an outer surface of the mobile terminal in the first folded state;
a selection module configured to select one of the first screen and the second screen as a display screen in accordance with the first image and the second image, and shut down the other one of the first screen and the second screen; and
a first control module configured to control the display screen for display.

8. The mobile terminal according to claim 7, wherein the selection module comprises:
a detection unit configured to detect whether any one of the first image and the second image comprises characteristic information, the characteristic information comprising face information or eyeball information;
a first selection unit configured to, when the first image comprises the characteristic information, select the first screen as the display screen, and shut down the second screen; and
a second selection unit configured to, when the second image comprises the characteristic information, select the second screen as the display screen, and shut down the first screen.

9. The mobile terminal according to claim 8, wherein the first selection unit is further configured to: perform identity authentication in accordance with the characteristic information comprised in the first image; and when the identity authentication is performed successfully, select the first screen as the display screen,
wherein the second selection unit is further configured to: perform the identity authentication in accordance with the characteristic information comprised in the second image;
and when the identity authentication is performed successfully, select the second screen as the display screen.

10. The mobile terminal according to claim 7, further comprising:
a detection module configured to, after the display screen has been controlled for display, detect whether a rotation angle of a space attitude of the mobile terminal is greater than a predetermined value; and
a switching module configured to, when the rotation angle of the space attitude of the mobile terminal is greater than the predetermined value, perform a switching operation between the first screen and the second screen for a display content.

11. The mobile terminal according to claim 7, wherein the first control module is further configured to:
when the foldable screen is switched from an unfolded state to the first folded state, scale down a display interface in the unfolded state on the foldable screen in accordance with a first predetermined proportion; and
display the scaled-down display interface on the display screen.

12. The mobile terminal according to claim 11, further comprising a second control module configured to:
when the foldable screen is switched from the first folded state to the unfolded state, scale up the display interface in the first folded state on the foldable screen in accordance with a second predetermined proportion; and
display the scaled-up display interface on the first screen and the second screen.

13. A mobile terminal, comprising a foldable screen, the foldable screen comprising a first screen and a second screen, the mobile terminal further comprising a memory, a processor and a computer program stored in the memory and executed by the processor, wherein the processor is configured to execute the computer program so as to implement the display control method according to claim 1.

14. The mobile terminal according to claim 13, wherein the selecting one of the first screen and the second screen as a display screen in accordance with the first image and the second image and shutting down the other one of the first screen and the second screen comprises:
detecting whether any one of the first image and the second image comprises characteristic information, the characteristic information comprising face information or eyeball information;
selecting the first screen as the display screen when the first image comprises the characteristic information, and shutting down the second screen; and
selecting the second screen as the display screen when the second image comprises the characteristic information, and shutting down the first screen.

15. The mobile terminal according to claim 14, wherein the selecting the first screen as the display screen when the first image comprises the characteristic information comprises:
performing identity authentication in accordance with the characteristic information comprised in the first image; and
selecting the first screen as the display screen when the identity authentication is performed successfully,
wherein the selecting the second screen as the display screen when the second image comprises the characteristic information comprises:
performing the identity authentication in accordance with the characteristic information comprised in the second image; and
selecting the second screen as the display screen when the identity authentication is performed successfully.

16. The mobile terminal according to claim 13, wherein subsequent to controlling the display screen for display, the processor is further configured to:
detect whether a rotation angle of a space attitude of the mobile terminal is greater than a predetermined value; and
perform a switching operation between the first screen and the second screen for a display content when the rotation angle of the space attitude of the mobile terminal is greater than the predetermined value.

17. The mobile terminal according to claim 13, wherein when the foldable screen is switched from an unfolded state to the first folded state, the processor is further configured to:
scale down a display interface in the unfolded state on the foldable screen in accordance with a first predetermined proportion; and
display the scaled-down display interface on the display screen.

18. The mobile terminal according to claim 17, wherein the processor is further configured to:
scale up the display interface in the first folded state on the foldable screen in accordance with a second predetermined proportion when the foldable screen is switched from the first folded state to the unfolded state; and
display the scaled-up display interface on the first screen and the second screen.
